(19) United States
(12) Patent Application Publication
(10) Pub. No.: US 2026/0080899 A1
(43) Pub. Date: Mar. 19, 2026

(54) SUBSTRATE FOR MAGNETIC DISK AND METHOD FOR MANUFACTURING SAME, AND MAGNETIC DISK

(71) Applicants: FURUKAWA ELECTRIC CO., LTD., Tokyo (JP); UACJ Corporation, Tokyo (JP)

(72) Inventors: Hideyuki HATAKEYAMA, Tokyo (JP); Koichiro TAKIGUCHI, Tokyo (JP)

(21) Appl. No.: 18/686,439

(22) PCT Filed: Aug. 25, 2022
(86) PCT No.: PCT/JP2022/032021

§ 371 Date: May 9, 2025

(30) Foreign Application Priority Data
Aug. 26, 2021 (JP) 2021-137728

(51) Int. Cl. G11B 5/73; G11B 5/00

(52) U.S. Cl. CPC G11B 5/73921; G11B 5/73919; G11B 2005/0021; G11B 2005/0024

(57) ABSTRACT

The present invention intends to provide a substrate for a magnetic disk and a method for manufacturing same, and a magnetic disk capable of holding high flatness after long-term use despite being thin, coping with a high capacity of hard disk, and improving long-term reliability thereof. In the substrate according to the present invention, when a process for heating a substrate at 120° C. for 30 minutes and then cooling the substrate at −40° C. for 30 minutes is defined as one cycle, the flatness PV of a surface of the substrate measured at 25° C. after a thermal impact test in which the cycle is repeatedly performed 200 times is not more than 12 μm. The present invention further encompasses a magnetic disk having a similar flatness PV under the same conditions. The present invention still further encompasses a method for manufacturing the substrate for a magnetic disk.

### TECHNICAL FIELD

The present invention relates to a substrate for a magnetic disk, and a method for manufacturing the same, and a magnetic disk. More specifically, the present invention relates to a substrate for a magnetic disk, and a method for manufacturing the same, and a magnetic disk, which are capable of holding an improved planar level even after long-term use although the wall is thin, coping with increase in hard disk capacity, and improving the long-term reliability.

### BACKGROUND ART

In recent years, due to rapid spread of cloud computing, hard disks for use in data centers are required to have increased capacities. To support this, measures have been taken that include increase in diameters of substrate for magnetic disks, and increase in the number of stacked substrates through reduction in thickness. However, the sizes of housings for hard disks are standardized and accordingly, it is difficult to increase the diameters more. Consequently, reduction in thickness of the substrate for a magnetic disk has been strongly demanded. However, the substrate with a reduced thickness has a reduced stiffness and accordingly, a physical error, such as head crash, tends to occur in use of the hard disk for a long time period. Accordingly, for example, a thin-wall substrate with a thickness less than 0.50 mm possibly has a large planar level, which causes adverse effects in use of the hard disk for a long time period, in comparison with a thick-wall substrate with a thickness of 0.50 mm or more.

Some discussions have been made about the flattening technique, in order to reduce the physical error in the hard disk (e.g., Patent Document 1). However, all of them focus only on the planar level after a fine polishing process. Such conventional flattened substrates have room for improvement in view of long-term reliability in an actual use environment.

### CITATION LIST

### Patent Document

Patent Document 1: Japanese Unexamined Patent Application, Publication No. 2015-135720

### DISCLOSURE OF THE INVENTION

### Problems to be Solved by the Invention

The present invention has an object to provide a substrate for a magnetic disk, a method for manufacturing the same, and a magnetic disk, which are capable of holding an improved planar level even after long-term use although the wall is thin, coping with increase in hard disk capacity, and improving the long-term reliability.

### Means for Solving the Problems

As a result of diligent study and discussion, the present inventors have found that a substrate for a magnetic disk and a magnetic disk that can support increase in hard disk capacity and have long-term reliability can be achieved by improving the planar level of a substrate after a thermal shock test performed as an accelerated test simulating an actual use environment, and have completed the present invention.

To achieve the object described above, the gist configuration of the present invention is as follows.

(1) A substrate for a magnetic disk having
a planar level PV of 12 μm or less measured at 25° C. on a surface of the substrate after a thermal shock test performed by repeating a cycle of heating the substrate at 120° C. for 30 minutes and subsequently cooling the substrate at −40° C. for 30 minutes for 200 times.
   (2) The substrate for a magnetic disk according to (1) described above, having a thickness dimension of less than 0.50 mm.
   (3) The substrate for a magnetic disk according to (1) or (2) described above, having an outer diameter dimension of 95 mm or more.
   (4) The substrate for a magnetic disk according to any of (1) to (3) described above, wherein a material of the substrate is glass or an aluminum alloy.
   (5) The substrate for a magnetic disk according to any of (1) to (4) described above, wherein the substrate is for a heat-assisted magnetic recording (HAMR) or microwave assisted magnetic recording (MAMR) magnetic disk.
   (6) A magnetic disk, having
a planar level PV of 12 μm or less measured at 25° C. on a surface of the magnetic disk after a thermal shock test performed by repeating a cycle of heating the magnetic disk at 120° C. for 30 minutes and subsequently cooling the magnetic disk at −40° C. for 30 minutes for 200 times.
   (7) A method for manufacturing the substrate for a magnetic disk according to any of (1) to (5) described above, including: a rough polishing step of roughly polishing both surfaces of a disk-shaped blank substrate; and a fine polishing step of finely polishing both the surfaces of the blank substrate subjected to rough polishing,
further including a dummy polishing step before the rough polishing step, wherein the dummy polishing step is performed with polishing pads to be used for the rough polishing step and a dummy substrate manufactured under the same conditions as the conditions for the blank substrate to adjust surfaces of the polishing pads to be used for the rough polishing step by polishing the dummy substrate with the polishing pads until the dummy substrate comes to have an arithmetic mean waviness Wa of less than 2.5 nm through measurement on at least one surface with a cutoff wavelength of 0.4 to 5.0 mm after rough polishing as in the rough polishing step, and
the rough polishing step further includes flipping front and back surfaces of the blank substrate in rough polishing of the blank substrate.

### Effects of the Invention

The present invention provides a substrate for a magnetic disk, and the magnetic disk, which are capable of holding an improved planar level even after long-term use although the wall is thin, coping with increase in hard disk capacity, and improving the long-term reliability.

### BRIEF DESCRIPTION OF THE DRAWINGS

FIG. 1 is a flowchart showing an example of a step of manufacturing a magnetic disk (an aluminum alloy substrate for the disk) according to the present invention; and

FIG. 2 is a flowchart showing an example of a step of manufacturing a magnetic disk (a glass substrate for the disk) according to the present invention.

### PREFERRED MODE FOR CARRYING OUT THE INVENTION

Hereinafter, a substrate for a magnetic disk, and a magnetic disk according to the present invention are described in detail.

The substrate for a magnetic disk and the magnetic disk according to the present invention have a planar level PV of 12 μm or less, measured at 25° C. on a surface of the substrate after a thermal shock test performed by repeating a cycle of heating the substrate at 120° C. for 30 minutes and subsequently cooling the substrate at −40° C. for 30 minutes 200 times.

Note that “planar level PV” is a value indicating the difference between the highest position (peak) and the lowest position (valley) of the substrate. The planar level can be measured using, for example, an interferometric planar level measuring instrument, through phase-measuring interferometry (phase shift method) at a predetermined measurement wavelength. Specifically, the planar level of the substrate may be measured using, for example, a light source with a measurement wavelength of 680 nm, through phase-measuring interferometry (phase shift method). Here, the substrate for a magnetic disk and the magnetic disk according to the present invention encompass an aspect where one of main surfaces (typically, a main surface to which a magnetic head is oppositely arranged) satisfies the planar level after the thermal shock test described above, and an aspect where the two main surfaces satisfy the planar level after the thermal shock test described above. Between them, the aspect where both the main surfaces satisfy the planar level PV after the thermal shock test is preferable. Accordingly, as for the planar level, both the principal surfaces may be measured, and the larger value may be adopted as a measured planar level of the substrate.

The planar level PV represents not only the surface roughness of the substrate, but also the flatness of the entire disk including the waviness, irregularities and the like of the substrate main body. Accordingly, the PV value of the substrate is important to improve the reliability of a hard disk. However, the planar level PV after the thermal shock test as described above has not been discussed yet so far.

### <Substrate>

The substrate for a magnetic disk according to the present invention may be formed of any of publicly known substrates. The size and material are not specifically limited. However, the advantageous effects of the present invention are significant particularly in a thin-wall substrate for a magnetic disk with a thickness dimension of less than 0.5 mm. Such a thin-wall substrate has a low stiffness and accordingly, a large planar level after long-term use largely affects the reliability of the hard disk. For the similar reason, the advantageous effects of the present invention are significant for a substrate for a magnetic disk having an outer diameter dimension of 95 mm or more.

The material of the substrate for a magnetic disk according to the present invention can be appropriately selected from among materials having been conventionally used, and may be, for example, an aluminum alloy, glass, etc. The substrate for a magnetic disk made of any of an aluminum alloy, glass and the like is resistant to any failure, and has favorable mechanical properties and workability. Accordingly, the substrate is suitable for the substrate for a magnetic disk according to the present invention.

The substrate for a magnetic disk according to the present invention may be used as a substrate for a magnetic disk for any recording scheme. Preferably, the substrate is used as any of heat-assisted magnetic recording (HAMR) and microwave assisted magnetic recording (MAMR) magnetic disk substrates. In the case of use as a magnetic disk substrate for HAMR, it is preferable to use a glass substrate, which is excellent in heat resistance. In the case of use as a magnetic disk substrate for MAMR, any of glass substrates and aluminum alloy substrates can be used.

### <Aluminum Alloy Substrate>

The substrate made of an aluminum alloy (sometimes simply called “aluminum alloy substrate” in Description of the present application) is resistant to any failure, the mechanical property and workability are favorable, and the cost is low. Accordingly, the substrate is suitable for a substrate for a magnetic disk. The material of the aluminum alloy substrate is not specifically limited either and various publicly known materials can be used. However, a conventionally used alloy containing an element, such as magnesium (Mg), copper (Cu), zinc (Zn), or chromium (Cr) is preferable. An element, such as iron (Fe), manganese (Mn), nickel (Ni) that can improve the stiffness can be contained. More preferably, any of alloys of A5000s or A8000s, in particular, A5086 is used. With such an alloy, the substrate is resistant to any failure, and can be provided with sufficient mechanical characteristics.

Examples of the specific composition of the aluminum alloy include, for example, A5086 that contains Mg: 3.5 to 4.5%, Fe: 0.50% or less, Si: 0.40% or less, Mn: 0.20 to 0.7%, Cr: 0.05 to 0.25%, Cu: 0.10% or less, Ti: 0.15% or less, and Zn: 0.25% or less, and the remaining parts made of Al and unavoidable impurities. A specific example of another composition of an aluminum alloy includes Mg: 1.0 to 6.5%, Cu: 0 to 0.070%, Zn: 0 to 0.60%, Fe: 0 to 0.50%, Si: 0 to 0.50%, Cr: 0 to 0.20%, Mn: 0 to 0.50%, Zr: 0 to 0.20%, and Be: 0 to 0.0020%, and the remaining parts made of aluminum and unavoidable impurities. Furthermore, for example, 0.1% or less of a component other than the components described above may be contained with respect to each element, with total 0.3% or less of the components contained. Note that for the compositions described above, every “%” means “% by mass”.

### <Glass Substrate>

The glass substrate is resistant to any failure, and has characteristics of favorable mechanical properties and workability, and advantages of being resistant to plastic deformation. Accordingly, the glass substrate is suitable for the substrate for a magnetic disk. The material is not specifically limited either. Glass ceramics, such as amorphous glass and crystallized glass can be used. Note that in view of the planar level, formability, and workability of the substrate, it is preferable to use amorphous glass. The material is not specifically limited. Examples of the material include aluminosilicate glass (aluminosilicate glass), soda-lime glass, soda-aluminosilicate glass, aluminoborosilicate glass, borosilicate glass (borosilicic acid glass), and further include physically strengthened glass, chemically strengthened glass and the like that have been subjected to a treatment, such as of air cooling or liquid cooling. However, there is no limitation thereto. Among them, aluminosilicate glass, in particular, amorphous aluminosilicate glass is preferable. A substrate made of such a material is excellent in the planar level and strength, and the long-term reliability can also be favorable.

For example, aluminosilicate glass that contains SiO₂: 55 to 75% as principal component, and contains Al₂O₃: 0.7 to 25%, Li₂O: 0.01 to 6%, Na₂O: 0.7 to 12%, K₂O: 0 to 8%, MgO: 0 to 7%, CaO: 0 to 10%, ZrO₂: 0 to 10%, and TiO₂: 0 to 1% has been known. In particular, aluminosilicate glass that contains SiO₂: 60 to 70%, Al₂O₃: 10 to 25%, Li₂O: 1 to 6%, Na₂O: 0.7 to 3%, K₂O: 0 to 3%, MgO: 0 to 3%, CaO: 1 to 7%, ZrO₂: 0.1 to 3%, and TiO₂: 0 to 1% has been known. The present invention can use a substrate made of such a material. Note that for the compositions described above and below, every “%” means “% by mass”.

In the glass composition described above, SiO₂ is a main component forming a framework of glass. If the content is 55% or more, high chemical durability tends to occur. If the content is 75% or less, there is a tendency that the melting temperature is not too high, and forming is facilitated.

Al₂O₃ is a component having an effect of improving the ion-exchange capability and the chemical durability. To exert such an effect, it is preferable that Al₂O₃ content is 0.7% or more. If the Al₂O₃ content is 25% or less, there is no possibility of degradation of the solubility and the devitrification resistance. Accordingly, it is preferable that Al₂O₃ content ranges between 0.7 and 25%.

Li₂O is a component having effects of ion-exchange with Na ions and chemically strengthening glass, improving the fusibility and formability, and improving the Young's modulus. To exert such effects, it is preferable that the Li₂O content is 0.01% or more. If the Li₂O content is 6% or less, there is no possibility of reducing the devitrification resistance and the chemical durability. Accordingly, it is preferable that the Al₂O₃ content ranges between 0.01 and 6%.

Na₂O is a component having effects of ion-exchange with K ions and chemically strengthening glass, reducing the high-temperature viscosity, improving the fusibility and formability, and improving the devitrification resistance. To exert such effects are exerted, it is preferable that the Na₂O is 0.7% or more. If the Na₂O content is 12% or less, it is preferable because there is no possibility of reducing the chemical durability and the Knoop hardness number.

Furthermore, K₂O, MgO, Cao, ZrO₂, and TiO₂ are optionally, additional components, which can be contained as needed.

K₂O is a component having effects of reducing the high-temperature viscosity, improving the fusibility, formability, and devitrification resistance. However, if the K₂O content exceeds 8%, there is a tendency that the low-temperature viscosity decreases, the thermal expansion coefficient increases, and the shock resistance decreases. Accordingly, it is preferable that the K₂O content ranges between 0 and 8%.

MgO and CaO are components having effects of reducing the high-temperature viscosity, improving the solubility, clarity, and formability, and improving the Young's modulus. In particular, CaO is contained as an essential component in soda-lime glass. Here, MgO and CaO are expected to have effects of reducing the high-temperature viscosity, improving the solubility, clarity, and formability, and improving the Young's modulus. If the MgO content exceeds 7% and/or the Cao content exceeds 10%, the ion-exchange performance and the devitrification resistance tend to decrease. Accordingly, it is preferable that the MgO content is 7% or less, and the Cao content is 10% or less.

ZrO₂ is a component having effects of increasing the Knoop hardness number, and improving the chemical durability and the heat resistance. However, if the ZrO₂ content exceeds 10%, the fusibility and the devitrification resistance tend to decrease. Accordingly, it is preferable that the ZrO₂ content ranges between 0 and 10%.

TiO₂ is a component having effects of reducing the high-temperature viscosity, improving the fusibility, stabilizing the structure, and improving the durability. However, if the TiO₂ content exceeds 1%, the ion-exchange performance and the devitrification resistance tend to decrease. Accordingly, it is preferable that the TiO₂ content ranges between 0 and 1%.

The glass having the composition described above may further include not only B₂O₃ having effects of reducing the viscosity, and improving the solubility and clarity, Sro or BaO having effects of reducing the high-temperature viscosity, improving the solubility, clarity, and formability, and improving the Young's modulus, ZnO that can improve the ion-exchange performance, and reduce the high-temperature viscosity without reducing the low-temperature viscosity, SnO₂ having effects of improving the clarity and the ion-exchange performance, and Fe₂O₃ that can function as a colorant, but also As₂O₃ and Sb₂O₃ as clarifying agents. Furthermore, oxides, such as lanthanum (La), phosphorus (P), cerium (Ce), antimony (Sb), hafnium (Hf), rubidium (Rb), and yttrium (Y) may be contained as trace elements. Note that B₂O₃ is contained as an essential component in alumino-borosilicate glass, and borosilicate glass. The glass may have a composition that contains SiO₂: 45 to 60%, Al₂O₃: 7 to 20%, B₂O₃: 1 to 8%, P₂O₅: 0.5 to 7%, CaO: 0 to 3%, TiO₂: 1 to 15%, BaO: 0 to 4%, and another oxide, such as MgO: 5 to 35%.

With the aluminum alloy substrate or the glass substrate that has the composition as described above, an improved planar level is exerted, and heat deformation unlikely occurs, and after a thermal shock test performed by repeating a cycle of heating the substrate at 120° C. for 30 minutes and subsequently cooling the substrate at −40° C. for 30 minutes 200 times, the planar level PV can be 12 μm or less, in particular, 10 μm or less. First, a representative aspect of a method of manufacturing an aluminum alloy substrate and a glass substrate (and a magnetic disk) indicating such a planar level, from the aluminum alloy or the glass described above is hereinafter described as an example.

### <Method for Manufacturing Aluminum Alloy Substrate>

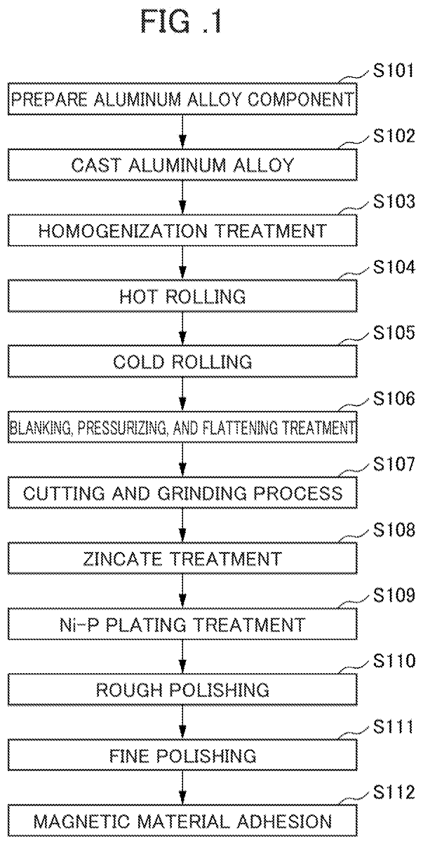

FIG. 1 is a flowchart showing an example of a step of manufacturing an aluminum alloy substrate for a magnetic disk, and a magnetic disk according to the present invention. In FIG. 1, an aluminum alloy component preparing step (step S101), an aluminum alloy casting step (step S102), a homogenization treatment step (step S103), a hot rolling step (step S104), and cold rolling (step S105) are steps of manufacturing an aluminum alloy material through melt casting, and forming an aluminum alloy plate from this material. Next, by a blanking, pressurizing, and flattening treatment step (step S106), a disk blank made of an aluminum alloy is manufactured. A pretreatment, such as a cutting process and grinding process step (step S107), is applied to the manufactured disk blank, and an annular aluminum alloy plate is fabricated. A zincate treatment step (step S108), and an electroless Ni—P plating treatment step (step S109) are applied to the substrate, and an aluminum alloy substrate for a magnetic disk is fabricated. The manufactured aluminum alloy substrate (blank substrate) for a magnetic disk is subjected to a rough polishing step (step S110), and a fine polishing step (step S111), and is made as a magnetic disk through a magnetic material adhesion step (step S112). Hereinafter, according to the flow of FIG. 1, the content of each step is described in detail.

First, a molten metal of the aluminum alloy material having the component composition described above is prepared by heating and melting according to a common procedure (step S101). Next, the prepared molten metal of aluminum alloy material is casted according to a semi-continuous casting (DC casting) method, a continuous casting (CC casting) method or the like, thus casting the aluminum alloy material (step S102). Preferably, the casting method is the DC casting method, in particular, a vertical semi-continuous casting method. In the DC casting method and the CC casting method, an aluminum alloy material manufacturing condition and the like are as follows.

According to the DC casting method, the molten metal poured through a spout is deprived of heat by a bottom block, a water-cooled mold wall, and cooling water directly discharged to the periphery of an ingot, set, and drawn below as an aluminum alloy ingot.

On the other hand, according to the CC casting method, a casting nozzle is inserted between a pair of rolls (or a belt caster, or a block caster), a molten metal is supplied, and heat is removed from the rolls, thus directly casting an aluminum alloy thin-plate.

The DC casting method and the CC casting method are largely different in the cooling rate in casting. The CC casting method with a higher cooling rate is characterized in that secondary phase particles have a smaller size than in DC casting.

The homogenization treatment is applied to a DC-cast aluminum alloy ingot as needed (step S103). When the homogenization treatment is applied, it is preferable to perform a heating treatment at 280 to 620° C. for 0.5 to 30 hours, and it is more preferable to perform a heating treatment at 300 to 620° C. for 1 to 24 hours. If the heating temperature of the homogenization treatment is less than 280° C. or the heating time period is less than 0.5 hours, there is a possibility that the homogenization treatment is insufficient, and the loss factor largely varies among individual aluminum alloy plates. If the heating temperature in the homogenization treatment exceeds 620° C., the aluminum alloy ingot is possibly melted. Even if the heating time period of the homogenization treatment exceeds 30 hours, the advantageous effect is saturated, and any further significant improvement effect cannot be achieved.

Next, a (DC-cast) aluminum alloy ingot having been subjected to the homogenization treatment as needed or to no homogenization treatment is hot-rolled, and is formed as a plate (step S104). The condition for the hot rolling is not specifically limited. However, it is preferable that the hot rolling start temperature ranges between 250 and 600° C., and the hot rolling end temperature ranges 230 between 450° C.

Next, a hot-rolled sheet, or a cast plate cast by the CC casting method is cold-rolled, and is formed as an aluminum alloy plate with, for example, about 0.30 to 0.60 mm (step S105). The cold rolling condition is not specifically limited, and may be defined depending on a required product plate strength and plate thickness. Preferably, the rolling ratio ranges between 10 and 95%.

Note that it is preferable to apply an annealing treatment in order to secure cold rolling workability before the cold rolling or in the cold rolling. It is preferable that the temperature of the annealing treatment ranges between 250 and 500° C., in particular, between 300 and 450° C. By applying the annealing treatment in such a condition, deformation unlikely occurs even in long-term use, and a favorable planar level can be held. More specific annealing condition can be, for example, holding at 300 to 450° C. for 0.1 to 10 hours in a batch-type heating, or holding at 400 to 500° C. for 0 to 60 seconds in the continuous-type heating. Here, a holding time of 0 seconds means cooling immediately after a desired holding temperature is reached.

The aluminum alloy plate obtained by cold rolling is punched into an annular shape, and thus an annular aluminum alloy plate is formed. Preferably, the annular aluminum alloy plate is formed as a disk blank by the blanking, pressurizing, and flattening treatment (step S106). Preferably, the blanking, pressurizing, and flattening treatment (also called “press annealing”) is performed at a temperature of the recrystallization temperature of the aluminum alloy or higher with an applied pressure of about 30 to 60 kg/cm². For example, in the atmosphere, a temperature of 250 to 500° C., in particular, 300 to 400° C. is held for about 0.5 to 10 hours, in particular, about 1 to 5 hours, thus fabricating a flattened blank.

The disk blank is subjected to the cutting process and grinding process (step S107), and the heating treatment as needed, before the subsequent zincate treatment. In the process, a chamfering process may be further applied to inner and outer peripheral end faces.

Next, the surface of the disk blank is degreased, etched, and is subjected to the zincate treatment (Zn-substituting treatment) (step S108). The degreasing can be performed using, for example, the commercially available degreasing solution AD-68F (made by C. Uyemura & Co., Ltd.) or the like under the condition at a concentration of 200 to 800 mL/L at a temperature of 40 to 70° C. for a treatment time period of 3 to 10 minutes. The etching may be performed by acid etching using the commercially available AD-107F (made by C. Uyemura & Co., Ltd.) etching solution under the condition at a concentration 20 to 100 mL/L at a temperature of 50 to 75° C. for a treatment time period of 0.5 to 5 minutes.

In the zincate treatment, a zincate film is formed on the surface of the disk blank. The zincate treatment can use a commercially available zincate treatment solution. Preferably, the treatment is performed under the condition at a concentration of 100 to 500 mL/L at a temperature of 10 to 35° C. for a treatment time period of 0.1 to 5 minutes. The zincate treatment is performed at least once, and may be performed twice or more. By performing the zincate treatment multiple times, Zn is finely deposited, and a uniform zincate film can be formed. In a case of performing the zincate treatment twice or more, a Zn peeling treatment may be performed. Preferably, the Zn peeling treatment is performed using HNO₃ solution under the condition at a concentration of 10 to 60% at a temperature of 15 to 40° C. for a treatment time period of 10 to 120 seconds (accordingly, also called “nitric acid peeling treatment”). Preferably, the second and subsequent zincate treatments are executed under the condition similar to that of the first zincate treatment.

Furthermore, for example, the electroless Ni—P plating treatment (step S109) is applied, as a base treatment for magnetic material adhesion, to the surface of the zincate treated disk blank. Preferably, the electroless Ni—P plating treatment step is performed using a commercially available solution, e.g., NIMUDEN (R) HDX made by C. Uyemura & Co., Ltd., under the condition at an Ni concentration: 3 to 10 g/L at a temperature: 80 to 95° C. for a treatment time period: 30 to 180 minutes.

The plating surface after the electroless Ni—P plating treatment is subjected to a polishing treatment (steps S110 to S111) as described later, and a substrate for a magnetic disk is obtained. A magnetic material is caused to adhere to the substrate (step S112), and is stacked as required, and thus a magnetic disk, such as a hard disk, can be manufactured.

### <Method for Manufacturing Glass Substrate>

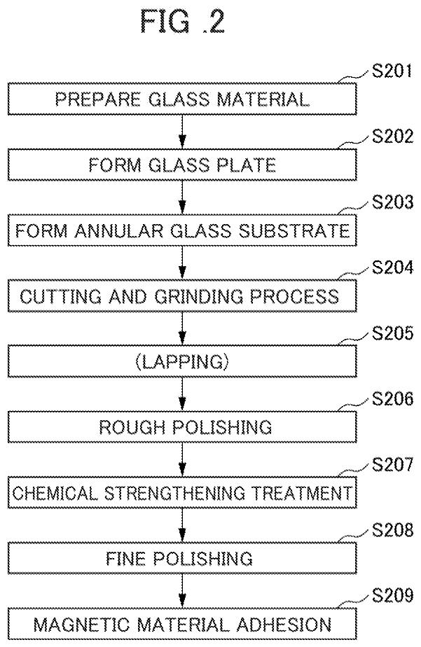

FIG. 2 is a flowchart showing an example of a step of manufacturing a glass substrate for a magnetic disk, and a magnetic disk according to the present invention. First, a glass plate having a predetermined thickness is prepared (steps S201 and S202). Next, the prepared glass plate is subjected to coring, and an end face polishing process is applied to the inner and outer peripheries, thus forming and processing an annular glass substrate (steps S203 and S204). Next, the formed glass substrate is subjected to lapping (step S205) using diamond pellets or the like, as required. Subsequently, or after step S204, a rough polishing step of integrally clamping the glass substrates from the top and bottom with polishing pads, and simultaneously polishing the glass substrates with, for example, cerium oxide abrasive grains is performed (step S206), and after a chemical strengthening treatment (step S207) is applied as required, a fine polishing step (step S208) with, for example, colloidal silica abrasive grains is performed. Next, a magnetic disk is manufactured by a magnetic material adhesion step (step S209). Hereinafter, according to the flow of FIG. 2, the content of each step is described in detail.

Hereinafter, each step is specifically described.

First, a melt of the glass material having the component composition described above is prepared by heating and melting according to a common procedure (step S201). Next, the prepared melt of the glass material is formed into a glass plate by a publicly known manufacturing method, such as the float method, down draw method, direct pressing method, redraw method, or fusion method (step S202). Here, it is preferable to use the redraw method of heating and softening a base glass plate manufactured using the float method or the like and of drawing the plate to have a desired thickness because a glass plate having a small variation in thickness can be relatively easily manufactured.

Next, an annular glass substrate is formed by the coring step from the glass plate obtained in step S202 (step S203). By the cutting and grinding process (step S204), the end faces of inner and outer peripheries may be polished. The formed glass substrate (glass blank) becomes an annular plate that has two main surface planes, and a circular hole formed at the center.

An annealing treatment (anneal treatment) may be applied to the obtained glass blank. For example, the annealing treatment can be performed by holding the glass blank at a temperature around the strain point for about 15 minutes or more, and gradually cooling for about 3 to 12 hours. Preferably, the temperature of the annealing treatment ranges between 250 and 750° C., in particular, between 50° and 700° C., depending on the glass material. By applying the annealing treatment in such a condition, deformation unlikely occurs even in long-term use, and a favorable planar level can be held. More specific annealing condition can be, for example, holding at 500 to 650° C. for 0.1 to 10 hours in a batch-type heating, or holding at 500 to 750° C. for 0 to 60 seconds in the continuous-type heating. Here, a holding time of 0 seconds means cooing immediately after a desired holding temperature is reached. For example, the glass substrate according to the present invention can be manufactured by forming the commercially available glass plate having the composition as described above into an annular shape and applying the annealing treatment.

Next, in step S205, the lapping process is optionally applied to the formed annular plate, thus adjusting the plate thickness. Note that depending on the plate thickness of the glass substrate obtained in the processes up to step S204, the lapping step S205 may be omitted, and the process may proceed to the following polishing step. For example, typically, the glass plate manufactured by the redraw method has a small variation in thickness. Accordingly, the lapping step S205 is not required to be executed. If the glass plate is manufactured by the float method or the direct pressing method, it is desirable to perform the lapping step S205. The lapping process can be executed using, for example, a batch-type double-sided polisher that uses diamond pellets.

The following polishing treatment (steps S206 to S208) is applied to the glass substrate (blank substrate) obtained as described above, and the substrate for a magnetic disk is thus obtained. A magnetic material is caused to adhere to the substrate (step S209), and is stacked as required, and a magnetic disk, such as a hard disk, can be manufactured.

Preferably, in the polishing treatment described above, between the rough polishing (step S206) and the fine polishing (step S208), the chemical strengthening treatment (step S207) is applied to the glass substrate. By chemical strengthening, lithium ions and sodium ions on the surface layer of the glass substrate are substituted respectively with sodium ions and potassium ions that have relatively large ion diameters in a chemically strengthening liquid. As a result, a compressive stress layer is formed in the surface layer portion, thus allowing the glass substrate to be strengthened. The chemical strengthening treatment method is not specifically limited, and for example, can be performed by soaking the glass substrate in the chemically strengthening liquid heated to 300 to 400° C. for about 3 to 4 hours. Here, the chemically strengthening liquid is not specifically limited either. For example, a mixture of potassium nitrate (60 weight percent) and sodium sulfate (40 weight percent) or the like can be used. Preferably, the glass substrate is cleaned before the chemical strengthening treatment, and is preheated to about 200 to 300° C. Preferably, the chemically strengthened glass substrate is subjected to a cleaning treatment. For example, after cleaning with an acid, such as sulfuric acid, cleaning may be further performed with pure water or the like.

### <Polishing Treatment>

Typically, the substrate for a magnetic disk is subjected to the polishing treatment for flattening before magnetic material adhesion, regardless of the material of the substrate. Preferably, in this polishing step, polishing in multiple stages is performed with the diameters of the polishing abrasive grains being adjusted. Typically, it is preferable to perform rough polishing and fine polishing using a double-sided simultaneous polisher. The substrate for a magnetic disk according to the present invention can also be polished using a commercially available double-sided simultaneous polisher. Preferably, before the rough polishing, dummy polishing is performed, and the surfaces of the polishing pads are controlled.

### (Double-Sided Polisher)

Typically, the double-sided simultaneous polisher includes: an upper surface plate and a lower surface plate that are made of cast iron; a carrier that holds a plurality of substrates between the upper surface plate and the lower surface plate; and polishing pads attached respectively to substrate contact surfaces of the upper surface plate and the lower surface plate. Typically, in the polishing treatment, the substrates are held between the upper surface plate and the lower surface plate by the carrier, and each substrate is clamped at a predetermined processing pressure by the upper surface plate and the lower surface plate. Each substrate is integrally clamped from the top and bottom with polishing pads. Next, while a polishing liquid is being supplied between the polishing pads and the individual substrates at a predetermined supply rate, the upper surface plate and the lower surface plate are rotated in different directions.

At this time, the carrier also rotates on its own axis by a sun gear. Accordingly, the substrates perform planetary motions. Accordingly, each substrate is slid on the surfaces of the polishing pads, and both the surfaces are simultaneously polished.

### (Rough Polishing)

The rough polishing treatment method is not specifically limited, and can be performed under any condition depending on the material of the substrate. For example, the rough polishing of the aluminum alloy plate can be performed using a polishing liquid containing alumina with particle diameters of 0.1 to 1.0 μm, and polishing pads made of hard or soft polyurethane or the like. The rough polishing of the glass substrate can be performed using a polishing liquid containing cerium oxide with particle diameters of 0.1 to 1.0 μm, and polishing pads made of hard polyurethane or the like. However, the condition for the rough polishing treatment is not limited to them. A desired one can be selected from among publicly known polishing treatment conditions. For example, instead of alumina and cerium oxide described above, abrasive grains made of silica, zirconium oxide, SiC, diamond or the like with a desired particle diameter may be used. Note that the hard property has a hardness (Asker-C) of 85 or higher measured by a measurement method defined by The Society of Rubber Industry, Japan Standard (compliance standard: SRIS0101), and the soft property has a hardness ranging between 60 and 80.

A specific rough polishing condition is affected also by the material of the adopted substrate and by steps to application of the rough polishing (e.g., steps S101 to S109 in manufacturing of the aluminum alloy substrate, and steps S201 to S205 in manufacturing of the glass substrate), and is difficult to be uniquely defined. There is no limitation to any specific condition. For example, the rough polishing condition for the aluminum alloy substrate may be a polishing time period ranging between 2 and 5 minutes, a polishing surface plate rotational speed ranging between 10 and 35 rpm, a sun gear rotational speed ranging between 5 and 15 rpm, a polishing liquid supply rate ranging between 1000 and 5000 mL/min., in particular, between 2000 and 4000 mL/min., a processing pressure ranging between 20 and 250 g/cm², preferably, between 20 and 120 g/cm², and a polishing amount ranging between 2.5 and 3.5 μm.

The rough polishing condition for the glass substrate is not specifically limited either. Preferably, for example, hard polishing pads having a hardness of 86 to 88 are used, the polishing surface plate rotational speed ranges between 10 and 35 rpm, the sun gear rotational speed ranges between 5 and 15 rpm, the polishing liquid supply rate ranges between 1000 and 5000 mL/min., the processing pressure ranges between 20 and 250 g/cm², more preferably, between 20 and 120 g/cm², and the polishing time period ranges between 2 and 10 minutes.

### (Dummy Polishing)

Preferably, in the polishing treatment, dummy polishing is performed and the surfaces of the polishing pads are controlled before the rough polishing as described above. Typically, the dummy polishing step is performed as in the rough polishing step, preferably under the same conditions thereof using a dummy substrate. The dummy substrate to be used is not specifically limited. For example, before the rough polishing of the glass substrate, dummy polishing can be performed using the aluminum alloy substrate. It is preferable to use a blank substrate of the same type as that for a product, in particular, a blank substrate manufactured under the conditions similar to those of a blank substrate for a product. In the dummy polishing step according to the present invention, it is preferable to polish the dummy substrate until the arithmetic mean waviness Wa through measurement on at least one surface of the blank substrate (as a dummy substrate) with a cutoff wavelength of 0.4 to 5.0 mm becomes less than 2.5 nm.

In the dummy polishing step, the arithmetic mean waviness Wa can be measured by a conventional method. For example, one of the main surfaces of the dummy substrate may be entirely measured using OptiFlat (trade name) made by Phaseshift Technologies Inc. By such dummy polishing, the surfaces of the polishing pads used for the rough polishing step described above can be adjusted to a favorable state. Note that the dummy polishing is an optional step. If the surfaces of the polishing pads are adjusted and controlled, the step may be omitted. For example, before the rough polishing is started, the dummy polishing is performed, which allows repetitive execution of multiple batches of rough polishing of the blank substrate for a product, with the adjusted polishing pads.

### (Fine Polishing)

The fine polishing method is not specifically limited, and may be performed according to any of various publicly known methods. For example, the fine polishing of an aluminum alloy substrate can be performed using a polishing liquid containing colloidal silica with a particle diameter of about 0.01 to 0.10 μm, and soft polishing pads. The fine polishing of a glass substrate can be performed using a polishing liquid containing colloidal silica with a particle diameter of about 0.01 to 0.10 μm, in particular, about 10 to 50 nm, and softer polishing pads that are made of urethane foam or the like. It is a matter of course that the condition for the fine polishing is not limited by them. Abrasive grains of cerium oxide, zirconium oxide, SiC, diamond or the like with a desired particle diameter may be used. By such a treatment, the main surface planes of the substrate are polished to mirror surfaces, thus manufacturing a substrate for a magnetic disk. The substrate for a magnetic disk according to the present invention having been subjected to the polishing step has a favorable planar level even after a thermal shock test, and exhibits a prescribed PV value. Preferably, the polished substrate is cleaned using a neutral detergent, pure water, IPA or the like.

A specific condition for fine polishing is also affected by the material of the adopted substrate and steps to the rough polishing. Accordingly, it is difficult to uniquely define the condition. There is no limitation to a specific condition. For example, in the fine polishing of the aluminum alloy substrate, a polishing time period may range between 2 and 5 minutes, a polishing surface plate rotational speed may range between 10 and 35 rpm, a sun gear rotational speed may range between 5 and 15 rpm, a polishing liquid supply rate may range between 1000 and 5000 mL/min., in particular, between 2000 and 4000 mL/min., a processing pressure may range, for example, between 10 and 200 g/cm², in particular, between 20 and 100 g/cm², and a polishing amount may range between 1.0 and 1.5 μm.

The glass substrate fine polishing condition is not specifically limited either. Preferably, for example, soft polishing pads having a hardness of 75 to 77 are used, the polishing surface plate rotational speed ranges between 10 and 35 rpm, the sun gear rotational speed ranges between 5 and 15 rpm, the polishing liquid supply rate ranges between 1000 and 5000 mL/min., in particular, between 2000 and 4000 mL/min., the processing pressure ranges between 10 to 200 g/cm², more preferably, between 20 to 100 g/cm², and the polishing time period ranges between 2 to 12 minutes.

### (Flipping)

Here, to manufacture the substrate for a magnetic disk according to the present invention, it is preferable to invert (flip) the front and back surfaces of the substrate in the polishing treatment. Thus, the polished substrate easily holds a favorable planar level even in long-term use. More preferably, flipping is performed in the rough polishing treatment. Also, in the double-side polishing, there is a tendency that the thickness of the layer removed by polishing is different between the upper surface plate and the lower surface plate of the substrate. In particular, in the rough polishing, the tendency is high. If a magnetic disk is fabricated using the thus polished substrate, deformation, such as waviness, occurs after long-term use, and the planar level is degraded in some cases. By performing flipping in the polishing treatment, particularly in the rough polishing treatment, the risk of deformation of the magnetic disk is reduced.

Although the flipping is only required to be performed once in the polishing treatment, the flipping may be performed twice or more. Preferably, flipping is performed so that both the surfaces of the substrate can be in contact respectively with the polishing pads on the upper surface plate and the lower surface plate under the same condition. For example, in the case of performing flipping once, the polishing rate and the polishing time period are made the same before and after the flipping. In the case of performing flipping multiple times, polishing is required to be performed so that the sum of time periods in which each surface is oriented upward and the sum of time periods in which the corresponding surface is oriented downward can be the same.

Through such a polishing step, a substrate for a magnetic disk can be manufactured to exhibit a prescribed PV value even after a thermal shock test. The present invention also encompasses a method for manufacturing a substrate for a magnetic disk, the method including: a rough polishing step of roughly polishing both surfaces of a disk-shaped blank substrate; and a fine polishing step of finely polishing both the surfaces of the roughly polished blank substrate, further including a dummy polishing step before the rough polishing step, wherein the dummy polishing step is performed with polishing pads to be used for the rough polishing step and a dummy substrate manufactured under the conditions identical to the conditions for the blank substrate to adjust surfaces of the polishing pads to be used for the rough polishing step by polishing the dummy substrate with the polishing pads until the dummy substrate comes to have an arithmetic mean waviness Wa of less than 2.5 nm through measurement on at least one surface with a cutoff wavelength of 0.4 to 5.0 mm after rough polishing as in the rough polishing step, and the rough polishing step further includes flipping front and back surfaces of the blank substrate in rough polishing of the blank substrate.

### <Substrate for Magnetic Disk>

According to the method as described above, the substrate for a magnetic disk according to the present invention can be manufactured. The substrate for a magnetic disk according to the present invention unlikely causes deformation even in long-time use, and a favorable planar level can be held. The planar level PV measured at 25° C. on the surface of the substrate after a thermal shock test is 12 μm or less, the thermal shock test performed by repeating a cycle of heating the substrate at 120° C. for 30 minutes and subsequently cooling the substrate at −40° C. for 30 minutes 200 times. Although the wall is thin, an improved planar level is held even after long-term use, for example, after 1000 thousand to 1500 thousand hours of use. Accordingly, a hard disk that allows scanning to be performed without interference between the main surface and the magnetic head, and has a large capacity and is excellent in long-term reliability can be formed. The substrate for a magnetic disk according to the present invention is particularly useful for a heat-assisted magnetic recording (HAMR) or microwave assisted magnetic recording (MAMR) magnetic disk.

### <Magnetic Disk>

The present invention also encompasses a magnetic disk where the planar level PV measured at 25° C. on the surface after a thermal shock test is 12 μm or less, the thermal shock test performed by repeating a cycle of heating the magnetic disk at 120° C. for 30 minutes and subsequently cooling the magnetic disk at −40° C. for 30 minutes 200 times.

The magnetic disk according to the present invention may be formed of any of publicly known substrates. The size and material are not specifically limited. However, it is preferable that the magnetic disk is based on an aluminum alloy substrate or a glass alloy substrate in order to achieve a magnetic disk having a more improved planar level. In order to make the advantageous effects of the present invention particularly significant, it is preferable to be based on a substrate having a thickness dimension of less than 0.5 mm, and an outer diameter dimension of 95 mm or more. More preferably, the disk is formed of the substrate for a magnetic disk according to the present invention. Particularly preferably, the disk is formed of the substrate for a magnetic disk made of the material obtained by the manufacturing method described above.

Even if the substrate for a magnetic disk according to the present invention is provided with a magnetic material layer on the surface, and a protective film layer and a lubricant film layer further thereon as required, the planar level after the thermal shock test is not substantially affected, and an improved planar level is held even after long-term use, thus achieving the object of the present application.

The embodiment of the present invention has thus been described above. However, the present invention is not limited by the embodiment described above, encompasses all the aspects included in the concept of the present invention and the claims, and can be variously modified within the scope of the present invention.

### EXAMPLES

Hereinafter, the present invention is described in further detail based on Examples. However, the present invention is not limited by them.

### Example 1

A5086 alloy (aluminum alloy A) was melted according to a common procedure, and was DC-cast, and a slab having a length of 7600 mm, a width of 1310 mm, and a plate thickness of 500 mm was fabricated. Each of the front and back surfaces of the fabricated slab was removed by 10 mm, a homogenization treatment at 540° C. for 6 hours was applied, and subsequently hot rolling was performed with a hot rolling start temperature of 540° C. and a hot rolling end temperature of 350° C., thus achieving a plate thickness of 3.0 mm. The hot-rolled plate was cold-rolled, thus achieving a plate thickness of 0.48 mm. The cold-rolled plate was punched by a press machine to have an inner diameter of φ24 mm×outer diameter of φ98 mm, was flattened by being subjected to a pressure annealing at 320° C. for 3 hours under a pressure of 30 kgf/cm². Furthermore, a cutting process was applied to the inner and outer peripheries, thus achieving an inner diameter of @25 mm×an outer diameter of q97 mm. In this case, a chamfering process was applied to the inner and outer peripheral end faces at the same time.

The surfaces of the substrate were ground with 4000s Sic grinding stones, thus achieving a plate thickness of 0.46 mm. The substrate was sequentially subjected to a degreasing treatment, and an acid etching treatment, and subsequently subjected to a zincate treatment.

The degreasing treatment was performed using, for example, the AD-68F degreasing solution made by C. Uyemura & Co., Ltd., under the conditions of a concentration: 500 mL/L, a temperature: 45° C., and a treatment time period: 3 minutes. The acid etching treatment was performed using, for example, the AD-107F etching solution made by C. Uyemura & Co., Ltd., under the conditions of a concentration: 50 mL/L, a temperature: 60° C., and a treatment time period: 2 minutes. The zincate treatment was performed twice with a nitric acid peeling treatment sandwiched in between. Specifically, the treatments were sequentially performed in an order of a first zincate treatment, pure water cleaning, a nitric acid peeling treatment, pure water cleaning, and a second zincate treatment. The first zincate treatment was performed using, for example, the AD-301F-3X zincate treatment solution made by C. Uyemura & Co., Ltd., under the conditions of a concentration: 200 mL/L, a temperature: 20° C., and a treatment time period: 1 minute. The nitric acid peeling treatment was performed under the conditions of a nitric acid concentration: 30% by volume, a temperature: 25° C., and a treatment time period: 1 minute. The second zincate treatment was performed under the same conditions as those of the first zincate treatment.

Subsequently, the electroless Ni—P plating treatment was performed. The electroless Ni—P plating treatment was performed using the NIMUDEN (R) HDX electroless plating solution made by C. Uyemura & Co., Ltd., under the conditions of an Ni concentration: 6 g/L, a temperature: 88° C., and a treatment time period: 130 minutes, thus forming an electroless Ni—P plating film having a thickness of 13 μm on each of both the surfaces.

A rough polishing treatment was applied to both the electroless-Ni—P-plated surfaces (front and back surfaces). The rough polishing treatment was performed through double-side polishing, using hard urethane polishing pads having a hardness of 87, and abrasive grains having a particle diameter of 0.4 μm. Note that in the rough polishing step, the polishing surface plate rotational speed was 30 rpm, the sun gear rotational speed was 10 rpm, the polishing liquid supply rate was 3500 cc/min, and the processing pressure was 100 g/cm². In the rough polishing treatment, the front and back surfaces of the substrate were inverted (flipped).

Note that before the rough polishing treatment described above, dummy polishing was performed. For the dummy polishing, another electroless-Ni—P-plated substrate fabricated in a manner similar to that described above was used as a dummy substrate. The dummy polishing was performed multiple times under the same conditions as the rough polishing conditions described above. At the sixth time, the OptiFlat Wa (arithmetic mean waviness measured with a cutoff wavelength of 0.4 to 5.0 mm: long-wavelength waviness) of the dummy substrate became less than 2.5 nm (2.19 nm). Accordingly, the dummy polishing was finished. Note that measurement of the arithmetic mean waviness Wa of the dummy substrate was performed using, for OptiFlat Wa, the OptiFlat (trade name) made by Phaseshift Technologies Inc., over the entire one surface of the roughly polished dummy substrate.

After the roughly polished substrate was cleaned with pure water, fine polishing was applied, and a substrate for a magnetic disk with a plate thickness (thickness dimension) of 0.48 mm was fabricated. The fine polishing was performed using soft urethane polishing pads with a hardness of 76, and colloidal silica abrasive grains with a particle diameter of 0.08 μm, under the conditions similar to the rough polishing conditions except that the polishing time period was 5 minutes, and the processing pressure was 50 to 100 g/cm². In other words, the fine polishing was performed where the polishing surface plate rotational speed was 30 rpm, the sun gear rotational speed was 10 rpm, and the polishing liquid supply rate was 3500 cc/min.

The substrate for a magnetic disk fabricated as described above was subjected to the thermal shock test, and the planar level was measured. The measurement result was shown in Table 1. Note that the thermal shock test, and the planar level measurement were performed under the following conditions.

### (Thermal Shock Test)

Using the bench-top type environmental test chamber SH-261 made by ESPEC CORP., the thermal shock test was executed by repeating a cycle of heating the substrate for a magnetic disk at 120° C. for 30 minutes, and subsequently cooling the substrate for a magnetic disk at −40° C. for 30 minutes 200 times.

### (Planar Level Measurement)

Measurement was performed using the MESA Horizontal made by Zygo Corporation. The measurement range was over both the entire main surfaces. The measurement was performed at 25° C. multiple times with n=3, and a mean value was adopted.

### Comparative Example 1

Operations similar to those in Example 1 were performed except that the condition for the press annealing was 200° C.×3 hours, and flipping was not performed in rough polishing treatment, thus fabricating a substrate for a magnetic disk having a plate thickness of 0.48 mm. A measurement result of the planar level was shown in Table 1 described later.

### Example 2

A glass material melt with a component composition containing SiO₂: 65% by mass, Al₂O₃: 18% by mass, Li₂O: 4% by mass, Na₂O: 1% by mass, K₂O: 0.2% by mass, CaO: 4% by mass, and ZrO₂: 0.8% by mass was heated and fused at 1600 to 1700° C., thus preparing a glass material (step S201). Next, the prepared glass material melt was formed by the redraw method into an aluminosilicate glass plate with 100 mm and a length of 10 m (step S202). Subsequently, a glass plate with a thickness close to 0.6 mm was selected, subjected to coring, and the end faces of the inner and outer peripheries were polished (cutting of the inner and outer diameters of the glass disk, dimension adjustment, chamfering process, and grinding process to chamfered portions), thus forming an annular glass substrate with an outer diameter of 97 mm and a circular hole inner diameter of 25 mm (steps S203 and S204).

Subsequently, the formed glass substrate was set in a double-sided polisher, and was subjected to a rough polishing treatment and a fine polishing treatment, thus fabricating a substrate for a magnetic disk with a plate thickness of 0.48 mm.

Note that in this Example, the blank substrate was fabricated by the redraw method, and the variation in plate thickness was allowed to be ignored. Accordingly, the lapping step in S205 was omitted. Since the polishing pads were controlled in a favorable state, the dummy polishing was not executed either. The rough polishing treatment used hard urethane polishing pads with a hardness of 87, and a polishing liquid containing loose grains obtained by applying pure water to cerium oxide polishing abrasive grains with an average particle diameter of 0.19 μm, and the polishing surface plate rotational speed was 25 rpm, the sun gear rotational speed was 10 rpm, and the polishing liquid supply rate was 1500 cc/min, and the processing pressure was 120 g/cm², and the front and back surfaces of the substrate were inverted (flipped) in the rough polishing process, and the operations were performed in a manner similar to that in Example 1.

The fine polishing treatment used soft urethane polishing pads with a hardness of 76, and a polishing liquid containing loose grains obtained by applying pure water to colloidal silica with an average particle diameter of 0.08 μm, and the polishing time period was 8.5 minutes, the processing pressure was 50 to 120 g/cm², and the operations were performed in a manner similar to that of Example 1. In other words, the fine polishing was performed where the polishing surface plate rotational speed was 30 rpm, the sun gear rotational speed was 10 rpm, and the polishing liquid supply rate was 3500 cc/min. The thickness dimension of the obtained substrate was 0.48 mm. A measurement result of the planar level was shown in Table 1.

### Comparative Example 2

Operations similar to those in Example 2 were performed except that flipping was not performed in the rough polishing treatment, thus fabricating a substrate for a magnetic disk. A measurement result of the planar level was shown in Table 1 described later.

TABLE 1
Planar level of each sample

| | | | Comparative | | Comparative |
|---|---|---|---|---|---|
| Example | | Example 1 | Example 1 | Example 2 | Example 2 |
| Sub- | Material | Aluminum alloy | | Aluminosilicate glass | |
| strate | Press- | 320° C. | 200° C. | — | — |
| | annealing | | | | |
| | Flipping | Applied | Null | Applied | Null |
| | Thickness | 0.48 | 0.48 | 0.48 | 0.48 |
| | (mm) | | | | |
| | Outer diam- | 97 | 97 | 97 | 97 |
| | eter (mm) | | | | |
| | Inner diam- | 25 | 25 | 25 | 25 |
| | eter (mm) | | | | |

| | | | | |
|---|---|---|---|---|
| Planar level PV | 3.7 | 15.1 | 7.6 | 14.7 |
| (μm) | | | | |
| (After thermal | | | | |
| shock test) | | | | |

According to the present invention, a substrate for a magnetic disk was provided where the planar level PV measured at 25° C. on a surface of the substrate after a thermal shock test was 12 μm or less, the thermal shock test performed by repeating a cycle of heating the substrate at 120° C. for 30 minutes and subsequently cooling the substrate at −40° C. for 30 minutes 200 times. The PV value of the aluminum alloy substrate in Example 1 after the thermal shock test was 3.7 μm, which was significantly below 12 μm. In other words, it was found that the substrate for a magnetic disk held an improved planar level even after long-term use although with the thin wall, was capable of supporting increase in hard disk capacity, and was capable of improving the long-term reliability. On the other hand, the PV value of the aluminum alloy substrate in Comparative Example 1 after the thermal shock test was 15.1 μm, which was larger than 12 μm. The PV value of the glass substrate in Example 2 after the thermal shock test was 7.6 μm, which was significantly below 12 μm. On the other hand, the PV value of the glass substrate in Comparative Example 2 after the thermal shock test was 14.7 μm, which was larger than 12 μm. The above description shows that in the case of the aluminum alloy substrate, by making the press-annealing temperature at the recrystallization temperature or higher, and performing flipping in the rough polishing treatment, and in the case of the glass substrate, by performing flipping in the rough polishing treatment, the PV value after the thermal shock test can be reduced.

### EXPLANATION OF REFERENCE NUMERALS

S101 Prepare aluminum alloy component
S102 Cast aluminum alloy
S103 Homogenization treatment
S104 Hot rolling
S105 Cold rolling
S106 Blanking, heating and flattening treatment
S107 Cutting and grinding process
S108 Zincate treatment
S109 Ni—P plating treatment
S110 Rough polishing
S111 Fine polishing
S112 Magnetic material adhesion
S201 Prepare glass material
S202 Form glass plate
S203 Form annular glass substrate
S204 Cutting and grinding process
S205 Lapping
S206 Rough polishing
S207 Chemical strengthening treatment
S208 Fine polishing
S209 Magnetic material adhesion

1. A substrate for a magnetic disk, having
a planar level PV of 12 μm or less measured at 25° C. on a surface of the substrate after a thermal shock test performed by repeating a cycle of heating the substrate at 120° C. for 30 minutes and subsequently cooling the substrate at −40° C. for 30 minutes for 200 times.

2. The substrate for a magnetic disk according to claim 1, having a thickness dimension of less than 0.50 mm.

3. The substrate for a magnetic disk according to claim 1, having an outer diameter dimension of 95 mm or more.

4. The substrate for a magnetic disk according to claim 1, wherein a material of the substrate is glass or an aluminum alloy.

5. The substrate for a magnetic disk according to claim 1, wherein the substrate is for a heat-assisted magnetic recording (HAMR) or microwave assisted magnetic recording (MAMR) magnetic disk.

6. A magnetic disk, having a planar level PV of 12 μm or less measured at 25° C. on a surface of the magnetic disk after a thermal shock test, the thermal shock test performed by repeating a cycle of heating the magnetic disk at 120° C. for 30 minutes and subsequently cooling the magnetic disk at −40° C. for 30 minutes 200 times.

7. A method for manufacturing the substrate for a magnetic disk according to claim 1, the method comprising: a rough polishing step of roughly polishing both surfaces of a disk-shaped blank substrate; and a fine polishing step of finely polishing both the surfaces of the blank substrate subjected to rough polishing,
further comprising a dummy polishing step before the rough polishing step, wherein the dummy polishing step is performed with polishing pads to be used for the rough polishing step and a dummy substrate manufactured under the same conditions as the conditions for the blank substrate to adjust surfaces of the polishing pads to be used for the rough polishing step by polishing the dummy substrate with the polishing pads until the dummy substrate comes to have an arithmetic mean waviness Wa of less than 2.5 nm through measurement on at least one surface with a cutoff wavelength of 0.4 to 5.0 mm after rough polishing as in the rough polishing step, wherein the rough polishing step further includes flipping front and back surfaces of the blank substrate in rough polishing of the blank substrate.

8. The substrate for a magnetic disk according to claim 2, having an outer diameter dimension of 95 mm or more.

9. The substrate for a magnetic disk according to claim 2, wherein a material of the substrate is glass or an aluminum alloy.

10. The substrate for a magnetic disk according to claim 8, wherein a material of the substrate is glass or an aluminum alloy.

11. The substrate for a magnetic disk according to claim 2, wherein the substrate is for a heat-assisted magnetic recording (HAMR) or microwave assisted magnetic recording (MAMR) magnetic disk.

12. The substrate for a magnetic disk according to claim 8, wherein the substrate is for a heat-assisted magnetic recording (HAMR) or microwave assisted magnetic recording (MAMR) magnetic disk.

13. The substrate for a magnetic disk according to claim 9, wherein the substrate is for a heat-assisted magnetic recording (HAMR) or microwave assisted magnetic recording (MAMR) magnetic disk.

14. The substrate for a magnetic disk according to claim 10, wherein the substrate is for a heat-assisted magnetic recording (HAMR) or microwave assisted magnetic recording (MAMR) magnetic disk.
